(19) United States
(12) Patent Application Publication
(10) Pub. No.: US 2015/0326442 A1
(43) Pub. Date: Nov. 12, 2015

(54) METHOD, NODE, AND GATEWAY FOR TRIGGERING NETWORKING

(71) Applicant: FANTEM TECHNOLOGIES (SHENZHEN) CO., LTD., Shenzhen (CN)

(72) Inventors: Jianhui Li, Shenzhen (CN); Winston Cheng, Shenzhen (CN); Zhen Zhang, Shenzhen (CN); Haibin Luo, Shenzhen (CN); Yiwei Zhu, Shenzhen (CN); Hao Zhan, Shenzhen (CN)

(21) Appl. No.: 14/659,196

(22) Filed: Mar. 16, 2015

(30) Foreign Application Priority Data
May 7, 2014 (CN) 201410190281.1
May 15, 2014 (CN) 201410205465.0
May 22, 2014 (CN) 201410221575.6
Aug. 6, 2014 (CN) 201410384114.0
Sep. 28, 2014 (CN) 201410507863.8

(51) Int. Cl. H04L 12/24; H04L 12/931; H04L 29/08; H04B 5/00

(52) U.S. Cl. CPC H04L 41/12; H04B 5/0075; H04L 49/35; H04L 67/16

(57) ABSTRACT

The present invention is applicable to the field of the Internet of Things, and provides a method, a node, and a gateway for triggering networking. The method includes receiving, by a node, non-contact trigger induction; and adding the node and a gateway to a same network. The present invention provides a convenient trigger manner to add a node and a gateway to a same network, and ensures that the node is added to a correct network, thereby facilitating a user to perform an operation of triggering networking.

### CROSS-REFERENCE TO RELATED APPLICATIONS

This application claims priority to and the benefit of, pursuant to 35 U.S.C. §119(a), Chinese Patent Application Nos. 201410190281.1, 201410205465.0, 201410221575.6, 201410384114.0 and 201410507863.8, filed May 7, 2014, May 15, 2014, May 22, 2014, Aug. 6, 2014 and Sep. 28, 2014, respectively, in the State Intellectual Property Office of P.R. China, which are incorporated herein by reference in their entireties.

### FIELD OF THE INVENTION

The present invention relates to the field of the Internet of Things, and more particularly, to a method, a node, and a gateway for triggering networking

### BACKGROUND OF THE INVENTION

Currently, with the development of Internet of Things technologies, more network connections and more extensive network connections are required between hardware devices. When connecting to a network, a traditional Internet of Things device usually uses a manner of automatically connecting to the network after the device is powered on. The manner of automatically connecting to the network is simple in operation after the device is powered on, but it is prone to a problem of a network connection error. In order to ensure that the connected network is a correct network, a physical key may be disposed on the Internet of Things device. When it needs to add the Internet of Things device to an Internet of Things network, the physical key on the Internet of Things device is pressed to trigger networking. A working state of the networking can be effectively controlled by using the physical key. However, in terms of the manner of trigger through pressing, for an Internet of Things device that is installed high, triggering by using a physical key is extremely inconvenient in operation.

Therefore, a heretofore unaddressed need exists in the art to address the aforementioned deficiencies and inadequacies.

### SUMMARY OF THE INVENTION

One of the objectives of the present invention is to provide a method, a node, and a gateway for triggering networking, so as to provide a convenient trigger manner to add the node and the gateway to a same network, and ensure that the node is added to a correct network, thereby facilitating a user to perform an operation of triggering networking.

In a first aspect, the present invention provides a method for triggering networking, including receiving, by a node, non-contact trigger induction, and adding the node and a gateway to a same network.

In one embodiment, the step of receiving, by the node, the non-contact trigger induction includes receiving, by the node, the trigger induction by receiving non-contact radio frequency identification induction; or receiving, by the node, the trigger induction by detecting a change of relative displacement information.

In another embodiment, the step of receiving, by the node, the non-contact trigger induction includes receiving, by the node through non-contact trigger, networking identification information indicating that the node and the gateway are added to the same network.

Further, after the step of receiving, by the node, the non-contact trigger induction, the method further includes generating, by the node, a first wireless networking command according to the received trigger induction, and then sending, by the node, the first wireless networking command.

In one embodiment, the first wireless networking command further includes identification authentication information of the node.

In a second aspect, the present invention provides a method for triggering networking, including receiving, by a gateway, networking information, and adding the gateway and a node to a same network, generating, by the gateway, a feedback command according to the received networking information, and then sending, by the gateway, the feedback command to the node.

In one embodiment, the step of receiving, by the gateway, the networking information includes at least one of receiving, by the gateway, the networking information by receiving a wireless command, and receiving, by the gateway, the networking information by receiving non-contact trigger induction.

In another embodiment, the step of receiving, by the gateway, the networking information by receiving the wireless command includes at least one of receiving, by the gateway, the networking information by receiving a wireless command sent by the node; and receiving, by the gateway, the networking information by receiving a wireless command sent by an intelligent device.

In one embodiment, the step of receiving, by the gateway, the networking information by receiving the non-contact trigger induction includes receiving, by the gateway, the trigger induction by receiving non-contact radio frequency identification induction; or receiving, by the gateway, the trigger induction by detecting a change of relative displacement information.

Further, the step of adding the gateway and the node to the same network specifically includes generating, by the gateway, a feedback command according to the received networking information; and then sending, by the gateway, the feedback command to the node.

In one embodiment, the step of generating, by the gateway, the feedback command according to the received networking information includes verifying, by the gateway, information about the node according to the received networking information; and after verification of the gateway on the node is successful, generating, by the gateway, the feedback command.

In one embodiment, the step of sending, by the gateway, the feedback command to the node includes sending, by the gateway, the feedback command to the node through non-contact radio frequency identification induction; or sending, by the gateway, the feedback command to the node by using a wireless command.

In a third aspect, the present invention provides a node including a first receiving unit, used for receiving, by a node, non-contact trigger induction; and a first networking unit, used for adding the node and a gateway to a same network, receive, by the node, a feedback command, and then add, according to the received feedback command, the node to a network in which the gateway is located.

In one embodiment, the first receiving unit includes a first radio frequency receiving unit, used for receiving, by the node, the trigger induction by receiving non-contact radio frequency identification induction; or a first displacement receiving unit, used for receiving, by the node, the trigger induction by detecting a change of relative displacement information.

In one embodiment, the node further includes a networking information receiving unit, used for receiving, by the node through non-contact trigger, networking identification information indicating that the node and the gateway are added to the same network.

In another embodiment, the node further includes a first command unit, used for generating, by the node, a first wireless networking command according to the received trigger induction, and then sending, by the node, the first wireless networking command.

In one embodiment, the first wireless networking command further includes identification authentication information of the node.

In a fourth aspect, the present invention provides a gateway including a second receiving unit, used for receiving, by a gateway, networking information; and a second networking unit, used for adding the gateway and a node to a same network, generate, by the gateway, a feedback command according to the received networking information, and then sending, by the gateway, the feedback command to the node.

In one embodiment, the second receiving unit includes at least one of a second wireless receiving unit, used for receiving, by the gateway, the networking information by receiving a wireless command; and a second induction receiving unit, used for receiving, by the gateway, the networking information by receiving non-contact trigger induction.

In one embodiment, the second wireless receiving unit includes at least of a second wireless node receiving unit, used for receiving, by the gateway, the networking information by receiving a wireless command sent by the node; and a second wireless device receiving unit, used for receiving, by the gateway, the networking information by receiving a wireless command sent by an intelligent device.

In one embodiment, the second induction receiving unit includes a second radio frequency unit, used for receiving, by the gateway, the trigger induction by receiving non-contact radio frequency identification induction; or a second displacement unit, used for receiving, by the gateway, the trigger induction by detecting a change of relative displacement information.

In one embodiment, the second networking unit includes a second feedback generating unit, used for generating, by the gateway, a feedback command according to the received networking information; and a second feedback sending unit, used for sending, by the gateway, the feedback command to the node.

In one embodiment, the second feedback generating unit of the second networking unit includes a second verification unit, used for verifying, by the gateway, information about the node according to the received networking information; and a second feedback unit, used for: after verification of the gateway on the node is successful, generating, by the gateway, the feedback command.

In one embodiment, the second feedback sending unit of the second networking unit includes second radio frequency feedback unit, used for sending, by the gateway, the feedback command to the node through non-contact radio frequency identification induction; or a second wireless feedback unit, used for sending, by the gateway, the feedback command to the node by using a wireless command.

According to the method, the node, and the gateway for triggering networking in the embodiments of the present invention, the node receives trigger induction and the node makes a corresponding response after receiving the trigger induction, and after the gateway receives networking information, the gateway and the node are added to a same network, to complete network establishment between the gateway and the node; during networking, according to different specific node triggering manners and preset networking manners, the gateway and the node can perform different operation feedbacks, to finally add the node and the gateway to the same network, thereby completing a networking operation between the node and the gateway. By providing different networking manners in which the node and the gateway are added to the same network, different operation feedbacks of adding the node to a network in which the gateway is located can be set for the node according to specific applications, and different networking configuration manners can be provided for different security and reliability, so that not only a user can be facilitated to perform a networking operation but also security of the entire network is ensured, and the node can be further set before being installed, so that usability of the node is higher, thereby facilitating installation and configuration.

These and other aspects of the present invention will become apparent from the following description of the preferred embodiment taken in conjunction with the following drawings, although variations and modifications therein may be effected without departing from the spirit and scope of the novel concepts of the invention.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment. The drawings do not limit the present invention to the specific embodiments disclosed and described herein. The drawings are not necessarily to scale, emphasis instead being placed upon clearly illustrating the principles of the present invention.

FIG. 1 is a flowchart of implementation of a method for triggering networking according to a first embodiment of the present invention.

FIG. 2 is a flowchart of implementation of a method for triggering networking according to a second embodiment of the present invention.

FIG. 3 is a structural diagram of a node according to a third embodiment of the present invention.

FIG. 4 is a structural diagram of a gateway according to a fourth embodiment of the present invention.

### DETAILED DESCRIPTION OF THE INVENTION

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the phrase “at least one of A, B, and C” should be construed to mean a logical (A or B or C), using a non-exclusive logical OR. It should be understood that one or more operations within a method is executed in different order (or concurrently) without altering the principles of the present disclosure.

As used herein, the term “unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules is executed using a single (shared) processor. In addition, some or all code from multiple modules is stored by a single (shared) memory. The term “group”, as used herein, means that some or all code from a single module is executed using a group of processors. In addition, some or all code from a single module is stored using a group of memories.

It should be noted that terms such as first and second, and the like may be used solely to distinguish one entity or action from another entity or action without necessarily requiring or implying any actual such relationship or order between such entities or actions. The terms, “comprises” and/or “comprising”, or “includes” and/or “including” or “has” and/or “having” when used in this specification, are intended to cover a non-exclusive inclusion, such that a process, method, article, or apparatus that comprises a list of elements does not include only those elements but may include other elements not expressly listed or inherent to such process, method, article, or apparatus. An element preceded by “comprises” or “comprising”, or “includes” or “including” or “has” or “having” does not, without more constraints, preclude the existence of additional identical elements in the process, method, article, or apparatus that comprises the element.

As used herein, the term “server” refers to a system including software and suitable computer hardware that responds to requests across a computer network to provide, or help to provide, a network service.

The systems and methods described herein are implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The terms “first”, “second”, “third”, “fourth” and so on (if any) in the specification, the claims and the accompanying drawings of the present invention are used to distinguish similar objects, but are not necessarily used to describe a particular order or sequence. It should be understood that, such data used can be interchanged under appropriate circumstances, so that the embodiments described herein can be implemented in an order except in an order in the content illustrated or described herein. In addition, the terms “comprise/include” and “have” as well as their any variations are intended to cover non-exclusive inclusion, for example, a process, a method, a system, a product or a device including a series of steps or units is not necessarily limited to the steps or units that are clearly listed, but may include other steps or units that are not clearly listed or that are inherent to the process, the method, the system, the product or the device.

According to the embodiments of the present invention, trigger is received at a node, then the node receives a feedback command sent by a gateway to the node, and the node is added, according to the received feedback command, to a network in which the gateway is located; the gateway receives networking information and generates the feedback command according to the networking information after receiving the networking information, and the gateway sends the feedback command to the node, to finally add the node conveniently to the network in which the gateway is located, thereby complete an operation of connecting the node to the network.

Without intent to limit the scope of the invention, specific implementation of the present invention is described below in detail with reference to specific embodiments.

### Embodiment 1

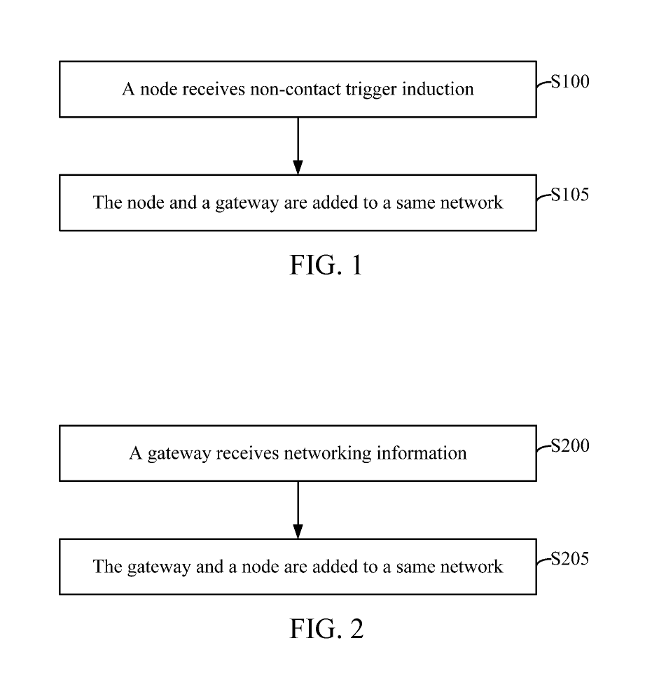

FIG. 1 illustrates a procedure of implementation of a method for triggering networking according to a first embodiment of the present invention, which is described in detail below:

In step S100, a node receives non-contact trigger induction.

During specific implementation, when a user needs to add a node to a network in which a gateway is located, the user may perform an operation on the node; and the node receives trigger induction through the corresponding operation, a function of the node is activated after the node receives the trigger induction, and after the function of the node is activated, the node may send and receive a command; at this time, the node is in an active state, where a manner of activating the node to be in an active state can be specifically implemented by controlling energization of a related module activated by the function of the node, and can also be implemented by controlling, by using a specific signal, a related module activated by the function of the node, where the specific signal may be an electrical signal, including a digital signal and a model signal, and a trigger induction signal received by the node when the node receives the trigger induction may specifically be a current change signal, and may also be specific identification information or a signal, for example, NFC identification information or a magnetic induction signal.

In step S105, the node and a gateway are added to a same network.

In this embodiment of the present invention, after the node is in an activated state, the node and the gateway can be added to the same network, which may specifically be as follows: The node receives a feedback command. The node receives the feedback command and performs a parsing operation on the feedback command, and the node can be added, according to information in the feedback command, to a network in which the gateway is located, thereby completing an operation of adding the node to the network in which the gateway is located. Before the node is added to the network in which the gateway is located, the gateway may be already in a networking state, and may also be in an isolated state without networking.

In combination with the method, preferably, in a first implementation manner, when the node receives the non-contact trigger induction, the node may directly coordinate with the gateway for trigger, and the node may also coordinate with another device, for example, the node coordinates with an intelligent device for non-contact trigger, and the node may receive the non-contact trigger induction by coordinating with a trigger device, where a manner in which the node receives the non-contact trigger induction may specifically be any one of the following trigger receiving manners:

The node receives the trigger induction by receiving non-contact radio frequency identification induction; and

The node receives the trigger induction by detecting a change of relative displacement information.

It should be noted that, the manner of the non-contact radio frequency identification induction may specifically include: radio frequency identification induction and Near Field Communication (NFC) technologies; and the receiving the trigger induction by detecting a change of relative displacement information includes: using a Hall sensor, a capacitive sensor, an inductive sensor, a photoelectric sensor, a pyroelectric sensor, a linear proximity sensor or displacement information change check sensors of other types, and when it is detected that the displacement information changes, a signal can be acquired through detection.

In combination with the method, preferably, in the first implementation manner, when the node receives the non-contact trigger induction, the node may further receive, when receiving the induction through non-contact trigger, networking identification information indicating that the node and the gateway are added to the same network, for example, the node receives, through radio frequency identification or NFC or by using a wireless command, the networking identification information that indicates that the node and the gateway are added to the same network and that is sent by the trigger device or the gateway to the node. When the node receives, through radio frequency identification, the networking identification information indicating that the node and the gateway are added to the same network, specifically, for example, if the node uses a passive NFC manner, in a case in which the node is not powered on, the node may further receive the networking identification information indicating that the node and the gateway are added to the same network; in this manner, an operation may be performed in specific application environments such as an application environment before the node is installed, after the node is installed and powered on, the node can be automatically added to a correct network, to facilitate a user for installation and use. The networking identification information indicating that the node and the gateway are added to the same network may be a login account and a password of the network in which the gateway is located and to which the node logs in, and may also be an intranet address assigned by the gateway to the node, and the node can be directly added, by using the intranet address, to the network in which the gateway is located.

In combination with the method, preferably, in the first implementation manner, when the node receives the non-contact trigger induction, the node may further receive, when receiving the non-contact trigger induction, identification or authentication information sent by the trigger device to the node, for example, the node and the trigger device perform trigger through radio frequency identification or NFC; during trigger, the node may receive first identification information transmitted by the trigger device through radio frequency identification or NFC or wireless communications to the node; the node receives device information sent by the trigger device to the node; when the node and the gateway perform networking, the gateway can implement identification authentication of the gateway on the node through the identification information, for example, when the gateway performs trigger with the node through another device, the another device may send the identification information to the node and the gateway separately, and when performing, through the received identification information, an operation of connecting the node to the network, the gateway can perform necessary authentication on the node by using the identification information of the node, thereby preventing the gateway from adding an unnecessary node to the network in which the gateway is located; the node may also receive the authentication information during trigger, for example, when the node receives non-contact trigger, the node receives network connection authentication information of joining the gateway, and by receiving, when performing trigger, the network connection authentication information of joining the gateway, the node can be added, by using the received network connection authentication information, to the network in which the gateway is located.

In combination with the method, preferably, in the first implementation manner, after the node receives the non-contact trigger induction, the node may further generate a first wireless networking command according to the received trigger induction, for example, after the node performs trigger with the first device and the node receives the trigger induction, the node generates a wireless networking command, and sends the wireless networking command generated by the node to the outside in a communication manner specific to the node, for example, the node and the gateway both support a mesh network protocol, the node sends the first wireless networking command through the mesh network protocol, and if the node needs to send the first wireless networking command to the trigger device, the node may send the first wireless networking command to the trigger device by communicating with the trigger device, and then, the trigger device may forward the first wireless networking command to the gateway by communicating, by the trigger device, with the gateway. Further, the first wireless networking command may further include identification authentication information of the node, and when the node generates the first wireless networking command, the node may add the identification authentication information of the node to the networking command. In the process of adding the node and the gateway to the same network, the gateway can perform identity authentication on the node by adding the identification authentication information of the node to the first wireless networking command, where the first wireless networking command sent by the node may be: a wireless command in a preset format, a wireless command in a preset encryption manner, or a wireless command in a preset command combination manner. In the process of adding the node and the gateway to the same network, the node may be added, according to feedback information of the received wireless command, to the network in which the gateway is located, specifically, one of the following manner may be used for adding: the node first directly or indirectly establishes a network connection to the gateway according to the feedback information of the wireless command, and then is added, according to the established network connection, to the network in which the gateway is located, where that the node is directly connected to the gateway means that the node and the gateway are not bridged through an intelligent device, and the indirect connection means that the node and the gateway need to be bridged through the intelligent device; or, the node or the intelligent device directly acquires, from the feedback information according to the feedback information of the wireless command, network configuration information assigned by the gateway to the node, then the node or the intelligent device directly completes setting of network configuration of the node according to the network configuration information, and after the setting of the network configuration of the node is completed, the node is added to the network in which the gateway is located, so as to implement the operation of adding the node to the network in which the gateway is located.

In the above manners, according to the method for triggering networking in this embodiment of the present invention, a node receives trigger induction, according to different specific node triggering manners and preset networking manners, the node can perform different operation feedbacks, to finally add the node and a gateway to a same network, thereby completing a networking operation between the node and the gateway. By providing different networking manners in which the node and the gateway are added to the same network, different operation feedbacks of adding the node to a network in which the gateway is located can be set for the node according to specific applications, and different networking configuration manners can be provided for different security and reliability, so that not only a user can be facilitated to perform a networking operation but also security of the entire network is ensured, and the node can be further set before being installed, so that usability of the node is higher, thereby facilitating installation and configuration. Meanwhile, according to the present invention, in a manner in which the node coordinates with the gateway to perform networking, a networking operation of the network can be completed within a shorter time; in this case, an incorrect device can be effectively prevented from being added to the network, thereby further ensuring the overall security performance of the network.

### Embodiment 2

FIG. 2 illustrates a procedure of implementation of a method for triggering networking according to a second embodiment of the present invention, which is described in detail below:

In step S200, a gateway receives networking information.

During specific implementation, when a user needs to add a node and a gateway to a same network, the user may perform a corresponding operation; the gateway can receive networking information through the corresponding operation, and the gateway can learn basic information of the node after receiving the networking information.

In step S205, the gateway and a node are added to a same network.

During specific implementation, after the gateway receives the networking information, the gateway performs an operation on the networking information, to identify necessary parameter information, and then the gateway assigns, to the node according to a network state of the gateway, an appropriate manner of adding the node to a network in which the gateway is located.

In combination with the method, preferably, in a second implementation manner, when the gateway receives the networking information, the gateway may receive the networking information in different manners, for example, the gateway receives the networking information by receiving a wireless command, and when the gateway receives the networking information by receiving a wireless command, the gateway may only receive a wireless networking command sent by the node, may also only receive a wireless networking command sent by an intelligent device, and may further receive wireless networking commands that are simultaneously sent by the intelligent device and the node, to receive the networking information. In addition to receiving the networking information by receiving a wireless command, the gateway may also receive the networking information by receiving non-contact trigger induction, for example, the receiving, by the gateway, the networking information by receiving non-contact trigger of the node and/or intelligent device on the gateway specifically includes: receiving, by the gateway, the trigger induction by receiving non-contact radio frequency identification induction; or receiving, by the gateway, the trigger induction by detecting a change of relative displacement information.

It should be noted that, in the process of receiving, by the gateway, the trigger induction through non-contact radio frequency identification induction, specifically, the gateway may receive the trigger induction by using a radio frequency chip or may receive the trigger induction through NFC, for example, the gateway receives trigger of the node or the intelligent device by using a radio frequency chip, to receive the networking information. When receiving trigger information by using the radio frequency chip or through NFC, the gateway may further receive identification authentication information. When receiving the trigger induction by detecting the change of the relative displacement information, the gateway may specifically receive the trigger induction by using a Hall sensor, a capacitive sensor, an inductive sensor, a photoelectric sensor, a pyroelectric sensor, a linear proximity sensor or sensors of other types; in addition, the gateway may further receive the trigger induction through, for example, wifi direct or a mobile communication data network or a mesh network protocol.

In combination with the method, preferably, in the second implementation manner, after the gateway receives the networking information, the gateway needs to perform an operation on the networking information, the gateway first checks in which manner the received networking information is received, for example, whether the networking information is received through non-contact trigger or the networking information is received by using a wireless command. As the networking information received in different manners is of different types, data information that can be carried in the networking information also varies, meanwhile, when the networking information is received, only the networking information sent by the node or the intelligent device may be received, or the networking information separately sent by the node and/or the intelligent device may be received, and the gateway separately performs different operations according to different information received, to add the node to the network in which the gateway is located, thereby adding the gateway and the node to the same network. In the process that the gateway adds the node to the same network, the gateway first generates a feedback command according to the received networking information, and then sends the feedback command to the node to add the node to the gateway. When the gateway receives the networking information sent by the node and the networking information sent by the intelligent device, the networking information sent by the node and the networking information sent by the intelligent device may respectively be networking information having a first identification key and networking information having a second identification key, and after receiving the networking information having the first identification key and the networking information having the second identification key, the gateway can complete information decryption processing or information authentication processing by using the two identification keys that are used in coordination, so as to further ensure the overall security of the network.

Further, preferably, the process of generating, by the gateway, a feedback command according to the received networking information specifically includes: verifying, by the gateway, information about the node according to the received networking information; and after verification of the gateway on the node is successful, generating, by the gateway, the feedback command; and in the process of sending, by the gateway, the feedback command to the node, the gateway may send the feedback command to the node through non-contact radio frequency identification induction or send the feedback command to the node by using a wireless command.

During specific implementation, the gateway needs to perform different processing according to different networking commands received, so as to add the node to the network in which the gateway is located, thereby completing a networking operation of the gateway and the node; and manners of performing a networking operation for different networking commands are described below. For example, when only the node and the gateway perform mutual trigger through the change of the relative displacement information, after the node and the gateway are triggered, the node and the gateway can perform networking communication by using mesh network protocols supported by themselves, for the gateway to add the node to the same network; where the mesh network protocols may specifically include: Z-Wave wireless networking protocols and ZigBee wireless networking protocols. In the process that the gateway and the node perform communication and networking, the gateway may also perform an identification authentication operation on the node. When the gateway and the node perform an operation, the gateway may also write, in the node through NFC, login information indicating that the node is added to the network in which the gateway is located, so that the gateway and the node are added to the same network by writing, in a storage device of the node, login information indicating that the network in which the gateway is located is logged in to.

In another specific implementation process, the intelligent device triggers the node, the intelligent device forwards all information before networking of the node and the gateway; at this time, after the intelligent device triggers the node, the node sends the information to the intelligent device according to a preset method after trigger, then the intelligent device sends the information to the gateway, and then the intelligent device receives the feedback command sent by the gateway to the node, to add the node to the network in which the gateway is located, thereby completing a networking operation of the node and the gateway; similarly, under some circumstances, the gateway and the node can also be added to the same network by writing, by the intelligent device in a storage device of the node, network connection information such as login information indicating that the node logs in to the network in which the gateway is located. In another specific embodiment, the node may also be triggered by the intelligent device, then the node and the intelligent device jointly send networking information to the gateway, and the gateway verifies the node according to the networking information sent by the node and the networking information sent by the intelligent device, and after the verification is successful, adds the node to the network in which the gateway is located.

In the above manners, according to the method for triggering networking in this embodiment of the present invention, after a gateway receives networking information, pertinent operations are performed for different manners of receiving the networking information, different numbers of received networking information, and different content in the specific networking information received, to finally add the gateway and a node to a same network; in a case in which a user selects different networking manners for different nodes, the gateway may also determines according to information received, so as to make different feedbacks according to the different manners of receiving the networking information, the different numbers of received networking information, and the different received content, to finally send a feedback command to the node, thereby implementing the operation of adding the gateway and the node to the same network; meanwhile, the gateway can perform different authentication and identification operations according to the different manners of receiving the networking information, the different numbers of received networking information, and the different received content, security and reliability of the entire network connected to the gateway can be ensured through different authentication and identification operations, and the node can be conveniently added to the network, which facilitates a pertinent networking operation.

### Embodiment 3

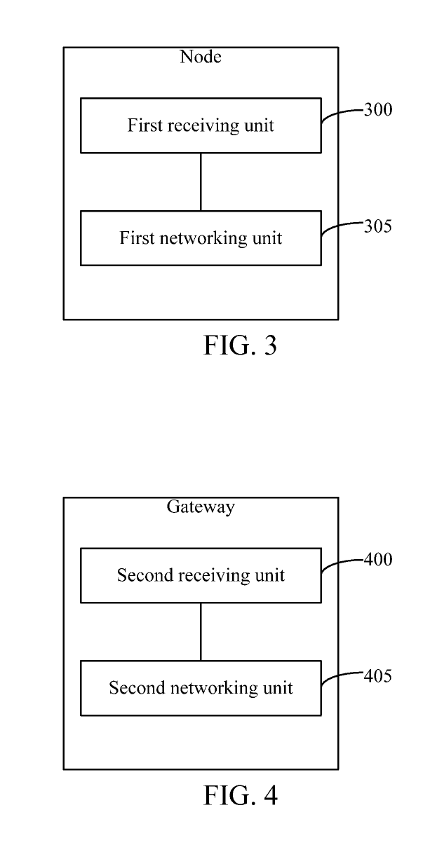

FIG. 3 illustrates a structural diagram of a node according to a third embodiment of the present invention. For ease of description, only the parts related to this embodiment of the present invention are illustrated.

A first receiving unit 300 is used for receiving, by a node, non-contact trigger induction.

During specific implementation, when a user needs to add a node to a network in which a gateway is located, the user may perform an operation on the node; and the node receives trigger induction through the corresponding operation, a function of the node is activated after the node receives the trigger induction, and after the function of the node is activated, the node may send and receive a command; at this time, the node is in an active state, where a manner of activating the node to be in an active state can be specifically implemented by controlling energization of a related module activated by the function of the node, and can also be implemented by controlling, by using a specific signal, a related module activated by the function of the node, where the specific signal may be an electrical signal, including a digital signal and a model signal, and a trigger induction signal received by the node when the node receives the trigger induction may specifically be a current change signal, and may also be specific identification information or a signal, for example, NFC identification information or a magnetic induction signal.

A first networking unit 305 is used for adding the node and a gateway to a same network.

In this embodiment of the present invention, after the node is in an activated state, the node and the gateway can be added to the same network, which may specifically be as follows: The node receives a feedback command. The node receives the feedback command and performs a parsing operation on the feedback command, and the node can be added, according to information in the feedback command, to a network in which the gateway is located, thereby completing an operation of adding the node to the network in which the gateway is located. Before the node is added to the network in which the gateway is located, the gateway may be already in a networking state, and may also be in an isolated state without networking

In combination with the method, preferably, in a third implementation manner, when the node receives the non-contact trigger induction, the node may directly coordinate with the gateway for trigger, and the node may also coordinate with another device, for example, the node coordinates with an intelligent device for non-contact trigger, and the node may receive the non-contact trigger induction by coordinating with a trigger device, where a manner in which the node receives the non-contact trigger induction may specifically be any one of the following trigger receiving manners: the node receives the trigger induction by receiving non-contact radio frequency identification induction; and the node receives the trigger induction by detecting a change of relative displacement information. A first radio frequency receiving unit receives the trigger induction by receiving non-contact radio frequency identification induction; or a first displacement receiving unit receives the trigger induction by detecting the change of the relative displacement information.

It should be noted that, the manner of the non-contact radio frequency identification induction may specifically include: radio frequency identification induction and NFC technologies; and the receiving the trigger induction by detecting a change of relative displacement information includes: using a Hall sensor, a capacitive sensor, an inductive sensor, a photoelectric sensor, a pyroelectric sensor, a linear proximity sensor or displacement information change check sensors of other types, and when it is detected that the displacement information changes, a signal can be acquired through detection.

In combination with the method, preferably, in the third implementation manner, when the node receives the non-contact trigger induction, the node may further receive, when receiving the induction through non-contact trigger by using a networking information receiving unit, networking identification information indicating that the node and the gateway are added to the same network, for example, the node receives, through radio frequency identification or NFC or by using a wireless command, the networking identification information that indicates that the node and the gateway are added to the same network and that is sent by the trigger device or the gateway to the node. When the node receives, through radio frequency identification, the networking identification information indicating that the node and the gateway are added to the same network, specifically, for example, if the node uses a passive NFC manner, in a case in which the node is not powered on, the node may further receive the networking identification information indicating that the node and the gateway are added to the same network; in this manner, an operation may be performed in specific application environments such as an application environment before the node is installed, after the node is installed and powered on, the node can be automatically added to a correct network, to facilitate a user for installation and use. The networking identification information indicating that the node and the gateway are added to the same network may be a login account and a password of the network in which the gateway is located and to which the node logs in, and may also be an intranet address assigned by the gateway to the node, and the node can be directly added, by using the intranet address, to the network in which the gateway is located.

In combination with the method, preferably, in the third implementation manner, when the node receives the non-contact trigger induction, the node may further receive, when receiving the non-contact trigger induction, identification or authentication information sent by the trigger device to the node, for example, the node and the trigger device perform trigger through radio frequency identification or NFC; during trigger, the node may receive first identification information transmitted by the trigger device through radio frequency identification or NFC or wireless communications to the node; the node receives device information sent by the trigger device to the node; when the node and the gateway perform networking, the gateway can implement identification authentication of the gateway on the node through the identification information, for example, when the gateway performs trigger with the node through another device, the another device may send the identification information to the node and the gateway separately, and when performing, through the received identification information, an operation of connecting the node to the network, the gateway can perform necessary authentication on the node by using the identification information of the node, thereby preventing the gateway from adding an unnecessary node to the network in which the gateway is located; the node may also receive the authentication information during trigger, for example, when the node receives non-contact trigger, the node receives network connection authentication information of joining the gateway, and by receiving, when performing trigger, the network connection authentication information of joining the gateway, the node can be added, by using the received network connection authentication information, to the network in which the gateway is located.

In combination with the method, preferably, in the third implementation manner, after the node receives the non-contact trigger induction, the node may further generate a first wireless networking command according to the received trigger induction by using a first command unit, for example, after the node performs trigger with the first device and the node receives the trigger induction, the first command unit of the node generates a wireless networking command, and sends the wireless networking command generated by the node to the outside in a communication manner specific to the node, for example, the node and the gateway both support a mesh network protocol, the node sends the first wireless networking command through the mesh network protocol, and if the node needs to send the first wireless networking command to the trigger device, the node may send the first wireless networking command to the trigger device by communicating with the trigger device, and then, the trigger device may forward the first wireless networking command to the gateway by communicating, by the trigger device, with the gateway. Further, the first wireless networking command may further include identification authentication information of the node, and when the node generates the first wireless networking command, the node may add the identification authentication information of the node to the networking command. In the process of adding the node and the gateway to the same network, the gateway can perform identity authentication on the node by adding the identification authentication information of the node to the first wireless networking command, where the first wireless networking command sent by the node may be: a wireless command in a preset format, a wireless command in a preset encryption manner, or a wireless command in a preset command combination manner. In the process of adding the node and the gateway to the same network, the node may be added, according to feedback information of the received wireless command, to the network in which the gateway is located, specifically, one of the following manner may be used for adding: the node first directly or indirectly establishes a network connection to the gateway according to the feedback information of the wireless command, and then is added, according to the established network connection, to the network in which the gateway is located, where that the node is directly connected to the gateway means that the node and the gateway are not bridged through an intelligent device, and the indirect connection means that the connection between the node and the gateway needs to be bridged through the intelligent device; or, the node or the intelligent device directly acquires, from the feedback information according to the feedback information of the wireless command, network configuration information assigned by the gateway to the node, then the node or the intelligent device directly completes setting of network configuration of the node according to the network configuration information, and after the setting of the network configuration of the node is completed, the node is added to the network in which the gateway is located, so as to implement the operation of adding the node to the network in which the gateway is located.

Through the above apparatus, according to the node in this embodiment of the present invention, the node receives trigger induction, according to different specific node triggering manners and preset networking manners, the node can perform different operation feedbacks, to finally add the node and a gateway to a same network, thereby completing a networking operation between the node and the gateway. By providing different networking manners in which the node and the gateway are added to the same network, different operation feedbacks of adding the node to a network in which the gateway is located can be set for the node according to specific applications, and different networking configuration manners can be provided for different security and reliability, so that not only a user can be facilitated to perform a networking operation but also security of the entire network is ensured, and the node can be further set before being installed, so that usability of the node is higher, thereby facilitating installation and configuration. Meanwhile, according to the present invention, in a manner in which the node coordinates with the gateway to perform networking, a networking operation of the network can be completed within a shorter time; in this case, an incorrect device can be effectively prevented from being added to the network, thereby further ensuring the overall security performance of the network.

### Embodiment 4

FIG. 4 illustrates a structural diagram of a gateway according to a fourth embodiment of the present invention. For ease of description, only the parts related to this embodiment of the present invention are illustrated.

A second receiving unit 400 is used for receiving, by a gateway, networking information.

During specific implementation, when a user needs to add a node and a gateway to a same network, the user may perform a corresponding operation; the gateway can receive networking information through the corresponding operation, and the gateway can learn basic information of the node after receiving the networking information.

A second networking unit 405 is used for adding the gateway and a node to a same network.

During specific implementation, after the gateway receives the networking information, the gateway performs an operation on the networking information, to identify necessary parameter information, and then the gateway assigns, to the node according to a network state of the gateway, an appropriate manner of adding the node to a network in which the gateway is located.

In combination with the method, preferably, in a fourth implementation manner, when the gateway receives the networking information, the gateway may receive the networking information in different manners, for example, the gateway receives the networking information by receiving a wireless command, and when the gateway receives the networking information by receiving a wireless command, the gateway may only receive a wireless networking command sent by the node, may also only receive a wireless networking command sent by an intelligent device, and may further receive wireless networking commands that are simultaneously sent by the intelligent device and the node, to receive the networking information. In addition to receiving the networking information by receiving a wireless command by using a second wireless receiving unit, the gateway may also receive the networking information by receiving non-contact trigger induction by using a second induction receiving unit, for example, the receiving, by the gateway, the networking information by receiving non-contact trigger of the node and/or intelligent device on the gateway by using a second wireless node receiving unit and/or a second wireless device receiving unit specifically includes: receiving, by the gateway, the trigger induction by receiving non-contact radio frequency identification induction; or receiving, by the gateway, the trigger induction by detecting a change of relative displacement information. In addition, the gateway may further receive the trigger induction through, for example, wifi direct or a mobile communication data network or a mesh network protocol.

It should be noted that, in the process of receiving, by the gateway, the trigger induction by receiving non-contact radio frequency identification induction by using a second radio frequency unit, specifically, the gateway may receive the trigger induction by using a radio frequency chip, or may receive the trigger induction through NFC, for example, the gateway receives trigger of the node or the intelligent device by using a radio frequency chip, to receive the networking information. When receiving trigger information by using the radio frequency chip or through NFC, the gateway may further receive identification authentication information. When receiving, by using the a second displacement unit, the trigger induction by detecting the change of the relative displacement information, the gateway may specifically receive the trigger induction by using a Hall sensor, a capacitive sensor, an inductive sensor, a photoelectric sensor, a pyroelectric sensor, a linear proximity sensor or sensors of other types.

In combination with the method, preferably, in the fourth implementation manner, after the gateway receives the networking information, the gateway needs to perform an operation on the networking information, the gateway first checks in which manner the received networking information is received, for example, whether the networking information is received through non-contact trigger or the networking information is received by using a wireless command. As the networking information received in different manners is of different types, data information that can be carried in the networking information also varies, meanwhile, when the networking information is received, only the networking information sent by the node or the intelligent device may be received, or the networking information separately sent by the node and/or the intelligent device may be received, and the gateway separately performs different operations according to different information received, to add the node to the network in which the gateway is located, thereby adding the gateway and the node to the same network. In the process that the gateway adds the node to the same network, the gateway first generates a feedback command according to the received networking information, and then sends the feedback command to the node to add the node to the gateway. When the gateway receives the networking information sent by the node and the networking information sent by the intelligent device, the networking information sent by the node and the networking information sent by the intelligent device may respectively be networking information having a first identification key and networking information having a second identification key, and after receiving the networking information having the first identification key and the networking information having the second identification key, the gateway can complete information decryption processing or information authentication processing by using the two identification keys that are used in coordination, so as to further ensure the overall security of the network.

Further, preferably, the process of generating, by the gateway, a feedback command according to the received networking information specifically includes: verifying, by the gateway, information about the node according to the received networking information by using a second verification unit; and after verification of the gateway on the node is successful, generating, by the gateway, the feedback command by using a second feedback unit; and, in the process of sending, by the gateway, the feedback command to the node, the gateway may send the feedback command to the node through non-contact radio frequency identification induction by using a second radio frequency feedback unit or send, by using a second wireless feedback unit, the feedback command to the node by using a wireless command.

During specific implementation, the gateway needs to perform different processing according to different networking commands received, so as to add the node to the network in which the gateway is located, thereby completing a networking operation of the gateway and the node; and manners of performing a networking operation for different networking commands are described below. For example, when only the node and the gateway perform mutual trigger through the change of the relative displacement information, after the node and the gateway are triggered, the node and the gateway can perform networking communication by using mesh network protocols supported by themselves, for the gateway to add the node to the same network; where the mesh network protocols may specifically include: Z-Wave wireless networking protocols and ZigBee wireless networking protocols. In the process that the gateway and the node perform communication and networking, the gateway may also perform an identification authentication operation on the node. When the gateway and the node perform an operation, the gateway may also write, in the node through NFC, login information indicating that the node is added to the network in which the gateway is located, so that the gateway and the node are added to the same network by writing, in a storage device of the node, login information indicating that the network in which the gateway is located is logged in to.

In another specific implementation process, the intelligent device triggers the node, the intelligent device forwards all information before networking of the node and the gateway; at this time, after the intelligent device triggers the node, the node sends the information to the intelligent device according to a preset method after trigger, then the intelligent device sends the information to the gateway, and then the intelligent device receives the feedback command sent by the gateway to the node, to add the node to the network in which the gateway is located, thereby completing a networking operation of the node and the gateway; similarly, under some circumstances, the gateway and the node can also be added to the same network by writing, by the intelligent device in a storage device of the node, network connection information such as login information indicating that the node logs in to the network in which the gateway is located. In another specific embodiment, the node may also be triggered by the intelligent device, then the node and the intelligent device jointly send networking information to the gateway, and the gateway verifies the node according to the networking information sent by the node and the networking information sent by the intelligent device, and after the verification is successful, adds the node to the network in which the gateway is located.

Through the above apparatus, according to the gateway in this embodiment of the present invention, after the gateway receives networking information, pertinent operations are performed for different manners of receiving the networking information, different numbers of received networking information, and different content in the specific networking information received, to finally add the gateway and a node to a same network; in a case in which a user selects different networking manners for different nodes, the gateway may also determines according to information received, so as to make different feedbacks according to the different manners of receiving the networking information, the different numbers of received networking information, and the different received content, to finally send a feedback command to the node, thereby implementing the operation of adding the gateway and the node to the same network; meanwhile, the gateway can perform different authentication and identification operations according to the different manners of receiving the networking information, the different numbers of received networking information, and the different received content, security and reliability of the entire network connected to the gateway can be ensured through different authentication and identification operations, and the node can be conveniently added to the network, which facilitates a pertinent networking operation.

In this embodiment of the present invention, there are descriptions about that the node receives the trigger induction by detecting the change of the relative displacement information, and there are also descriptions about that the gateway receives the trigger induction by detecting the change of the relative displacement information, and generally, at least two devices perform the trigger induction, for example, if one thereof is the node, the other may be the gateway; in order to provide clear descriptions, the two devices are separately called a first Internet of Things device and a second Internet of Things device, and the technical solution in which the first Internet of Things device and the second Internet of Things device receive the trigger induction by detecting the change of the relative displacement information, to perform networking is described in detail below:

First Solution:

Step S1001: The first Internet of Things device triggers a first induction signal according to a change of information of relative displacement with the second Internet of Things device.

In this solution, when the relative displacement between the first Internet of Things device and the second Internet of Things device changes, as when displacement between Internet of Things devices changes, displacement sensors on the Internet of Things devices may produce corresponding induction, for example, the first Internet of Things device is installed with a Hall element, and the second Internet of Things device is installed with a magnetic element, when the relative displacement between the second Internet of Things device and the first Internet of Things device changes, the Hall element on the first Internet of Things device may produce magnetic induction to the magnetic element on the second Internet of Things device; in a case in which the magnetic induction changes, the Hall element generates an electrical signal, the electrical signal may be directly transmitted to a processor on the first Internet of Things device or be amplified and then transmitted to the processor on the first Internet of Things device, and the first Internet of Things device triggers a first induction signal according to the transmitted electrical signal. The displacement induction trigger between the first Internet of Things device and the second Internet of Things device may use a Hall sensor, a capacitive sensor, an inductive sensor, a photoelectric sensor, a pyroelectric sensor, a linear proximity sensor or sensors of other types.

Step S1002: The second Internet of Things device triggers a second induction signal according to the change of the information of the relative displacement with the first Internet of Things device.

In this solution, the second Internet of Things device may also trigger a second induction signal according to a change of relative displacement of the first Internet of Things device, a method of generating a trigger induction signal may be the same as a manner in which the first Internet of Things device generates a signal, and meanwhile, in order to ensure that component induction on the first Internet of Things device and the second Internet of Things device is not disordered, preferably, the first Internet of Things device and the second Internet of Things device use displacement sensors of different types when producing the displacement induction trigger, thereby preventing inductive components on the Internet of Things devices from producing self-induction.

Step S1003: The first Internet of Things device triggers a networking request according to the first induction signal, and the second Internet of Things device triggers a networking request according to the second induction signal.

In this solution, as both the first Internet of Things device and the second Internet of Things device trigger and generate an induction signal when the relative displacement changes; the first induction signal triggered by the first Internet of Things device and the second induction signal triggered by the second Internet of Things device are almost sent at the same time; and the first Internet of Things device triggers the networking request according to the first induction signal, and the second Internet of Things device triggers the networking request according to the second induction signal; at this time, displacement between the first Internet of Things device and the second Internet of Things device is relatively small, and the first Internet of Things device and the second Internet of Things device can quickly establish the Internet of Things between the devices.

According to this solution, in the above manner, when relative displacement between Internet of Things devices changes, specifically, when close contact or non-contact occurs between the Internet of Things devices, the Internet of Things devices trigger a networking request separately according to displacement sensors, so as to establish an Internet of Things network between the Internet of Things devices.

Second Solution:

Step S2001: When information about displacement between the second Internet of Things device and the first Internet of Things device changes, the first Internet of Things device detects a change of displacement of the second Internet of Things device.

In this solution, when the displacement between the second Internet of Things device and the first Internet of Things device changes, specifically, when a user holds the second Internet of Things device to cause a change of the relative displacement between the second Internet of Things device and the first Internet of Things device, where the change of the relative displacement may specifically be that a spatial distance between the Internet of Things devices is small, or may be a rapid change of spatial displacement and a change of a designated position in spatial displacement, when the relative displacement between the first Internet of Things device and the second Internet of Things device changes, as the Internet of Things devices are disposed with displacement sensors that are used in coordination, when the relative displacement between the Internet of Things devices changes, the displacement sensors on the Internet of Things devices detect the relative displacement between the Internet of Things devices, for example, the first Internet of Things device is installed with a Hall element, and the second Internet of Things device is installed with a magnetic element, and when the relative displacement between the second Internet of Things device and the first Internet of Things device changes, the Hall element on the first Internet of Things device detects a magnetic field change generated by the magnetic element on the second Internet of Things device, so as to detect the change of the displacement of the second Internet of Things device according to the magnetic field change. The displacement sensors used between the Internet of Things devices may be Hall sensors, capacitive sensors, inductive sensors, photoelectric sensors, pyroelectric sensors, linear proximity sensors or other sensors, or identification devices of the radio frequency identification type may be used as the displacement sensors, or NFC devices may be used as the displacement sensors.

Step S2002: When the change of the displacement of the second Internet of Things device meets a preset relative displacement information change, the first Internet of Things device triggers a first induction signal.

In this solution, the displacement sensor on the first Internet of Things device detects the relative displacement between the second Internet of Things device and the first Internet of Things device. When the change of the displacement between the second Internet of Things device and the first Internet of Things device meets a preset displacement change, where that the change of the displacement of the second Internet of Things device meets a preset displacement change may be an approach distance of a spatial distance, or a rapid change of spatial displacement and a change of a designated action in the spatial displacement, a movement change of the spatial displacement may be a change direction and/or a change speed of the spatial displacement, and the change of the designated action in the spatial displacement may be a change of a designated gesture, when the change of the displacement of the second Internet of Things device meets the preset displacement change, the displacement sensor receives corresponding displacement change information, and the displacement sensor converts the received displacement change information to an electrical signal change or transmission communication data information. When the displacement change information is converted to the electrical signal change, the displacement sensor mainly used may be: a Hall sensor, a capacitive sensor, an inductive sensor, a photoelectric sensor, a pyroelectric sensor, a linear proximity sensor or an identification device of the radio frequency identification type. When the displacement change information is converted to the transmission communication data information for triggering an induction signal, a device using NFC is mainly used as the displacement sensor, the displacement change may be determined by using multiple sensors that are used in coordination, or signal determining may be performed on a signal received by the sensor to determine whether the change of the displacement between the Internet of Things devices meets the preset displacement change, and when it is determined that the change of the displacement of the second Internet of Things device meets the preset relative displacement information change, the first Internet of Things device triggers the first induction signal.

Step S2003: When information of the displacement between the first Internet of Things device and the second Internet of Things device changes, the second Internet of Things device detects a change of displacement of the first Internet of Things device.

In this solution, when the second Internet of Things device detects the change of the displacement between the first Internet of Things device and the second Internet of Things device, a displacement information induction detection solution that is the same as that used when the first Internet of Things device detects the second Internet of Things device can be used; however, in order to prevent a signal from being interfered, when detecting the change of the displacement between the first Internet of Things device and the second Internet of Things device, the second Internet of Things device may use a displacement information induction detection solution of a kind that is different from that used when the first Internet of Things device detects the second Internet of Things device or a displacement information induction detection solution of the kind that is the same as but has a frequency band that is different from that used when the first Internet of Things device detects the second Internet of Things device. Preferably, the second Internet of Things device may also detect, by using a second Internet of Things, the change of the displacement between the first Internet of Things device and the second Internet of Things device by using NFC technologies, for example, an NFC tag is set on the first Internet of Things device, and an NFC tag read/write apparatus is disposed on the second Internet of Things device, when the information of the displacement between the first Internet of Things device and the second Internet of Things device changes, the NFC tag read/write apparatus on the second Internet of Things device detects a distance between the second Internet of Things device and the first Internet of Things device, and in a readable distance, the NFC tag read/write apparatus reads information on the NFC tag, so as to detect the change of the displacement of the second Internet of Things device to the first Internet of Things device by using a distance.

Step S2004: When the change of the displacement of the first Internet of Things device meets the preset relative displacement information change, the second Internet of Things device triggers a second induction signal.

In this solution, when the change of the displacement between the first Internet of Things device and the second Internet of Things device meets the preset displacement change, the second Internet of Things device triggers the second induction signal, where that the change of the displacement of the first Internet of Things device meets the preset displacement change may be an approach distance of a spatial distance, or a rapid change of spatial displacement and a change of a designated action in the spatial displacement, a movement change of the spatial displacement may be a change direction and/or a change speed of the spatial displacement, and the change of the designated action in the spatial displacement may be a change of a designated gesture, and the manner in which the second Internet of Things device triggers the second induction signal may be a potential signal change, or transmission communication data information. When the displacement change information is converted to an electrical signal change, the displacement sensor used may be: a Hall sensor, a capacitive sensor, an inductive sensor, a photoelectric sensor, a pyroelectric sensor, a linear proximity sensor and an identification device of the radio frequency identification type. When the displacement change information is converted to the transmission communication data information for triggering an induction signal, a device using NFC is mainly used as the displacement sensor, when the first Internet of Things device and the second Internet of Things device use a solution of the radio frequency identification type as a signal trigger solution at the same time, the first Internet of Things device and the second Internet of Things device may use signals at different frequency bands to distinguish the signals, thereby preventing the signals from being interfered, specifically, transmission of communication data is established through NFC, the second induction signal is triggered by using the potential signal change or communication data information. When the second induction signal is triggered by using the communication data information, authentication information of the device may also be transmitted in the communication data information, for example, an NFC tag read/write apparatus performs reading/writing authentication on an NFC tag; during specific implementation, when a distance between the first Internet of Things device and the second Internet of Things device is close to a certain distance, the NFC tag read/write apparatus on the second Internet of Things device can read the NFC tag of the first Internet of Things device, the second Internet of Things device triggers the second induction signal according to the read NFC tag. An NFC identification manner between the second Internet of Things device and the first Internet of Things device may also be replaced with another radio frequency identification manner, preferably, in the case of the NFC manner, during data communication, through NFC, the second Internet of Things device can also identify the first Internet of Things device and read device related information of the first Internet of Things device by reading the NFC tag of the first Internet of Things device, for example, reading operation instructions of the first Internet of Things device and authentication data of the first Internet of Things device.

Step S2005: The first Internet of Things device triggers a networking request according to the first induction signal, and the second Internet of Things device triggers a networking request according to the second induction signal.

In this solution, as both the first Internet of Things device and the second Internet of Things device trigger and generate an induction signal when the relative displacement changes, the first induction signal triggered by the first Internet of Things device and the second induction signal triggered by the second Internet of Things device are almost sent at the same time, and the first Internet of Things device triggers the networking request according to the first induction signal, and the second Internet of Things device triggers the networking request according to the second induction signal; at this time, spatial positions of the first Internet of Things device and the second Internet of Things device are usually relatively close, and the first Internet of Things device and the second Internet of Things device can quickly establish the Internet of Things between the devices.

According to this solution, in the above manner, the first Internet of Things device triggers the first induction signal according to the change of the displacement of the second Internet of Things device relative to the first Internet of Things device, meanwhile, the second Internet of Things device triggers the second induction signal according to the change of the displacement of the first Internet of Things device relative to the second Internet of Things device, and the first Internet of Things device and the second Internet of Things device separately perform a networking operation according to the first induction signal and the second induction signal, to complete a networking action on the Internet of Things devices. The first Internet of Things device and the second Internet of Things device can be interchanged, and displacement information induction check components on the first Internet of Things device and the second Internet of Things device can also be interchanged. When an induction signal is triggered through NFC, device related information, for example, operation instructions of the device, may be pre-written in an NFC tag, an NFC tag read/write apparatus can generate a trigger induction signal when reading/writing the NFC tag, and can also acquire the device related information, and by using information read/written on the NFC tag, a necessary verification operation may also be performed on the device, thereby ensuring networking security.

In this embodiment of the present invention, the specific implementation manner in which the node receives the non-contact trigger induction includes the manner that the node receives, through non-contact trigger, networking identification information indicating that the node and the gateway are added to the same network, actually, this is also a problem of how a master device (such as a gateway) adds a terminal device (such as a node) to a same network, and a specific implementation manner of the manner may include:

Solution 1:

Step S1101: A master device writes networking identification information in a tag of a terminal device by using an NFC technology.

In this solution, when it needs to construct an Internet of Things network between Internet of Things devices, identification is first performed between the master device and the terminal device, where the identification between the master device and the terminal device may be performed by using an NFC technology. After the master device and the terminal device are identified through NFC, the master device writes, in a tag of the terminal device through NFC, networking identification information indicating that the terminal device is added to a network in which the master device is located. The networking identification information may be network identification information of the network in which the master device is located, the terminal device can identify, by using the network identification information, the network in which the master device is located, and the networking identification information may also be a key of encrypted network transmission data. The terminal device can decrypt, by using the key, the encrypted network transmission data sent by the device in the network in which the master device is located, so that the terminal device can perform network identification on different networks.

Step S1102: After the terminal device is powered on and activated, add, according to the networking identification information written in the tag, the terminal device to the network in which the master device is located.

In this solution, the terminal device may write the networking identification information in the tag of the terminal device through NPC in a case in which the terminal device is not powered on, and the terminal device may also write the networking identification information in the tag of the terminal device through NPC in a case in which the terminal device is powered on. After the terminal device is powered on and activated, the terminal device reads the networking identification information in the tag, and then is added to the corresponding network according to the networking identification information. According to different networking identification information, an operation when the terminal device is added to the network in which the master device is located varies, when the networking identification information is network identification information, the terminal device can directly determine, according to the network identification information, a specific network to which the terminal device is to be added, so as to be added, according to the network identification information, to the network in which the master device is located, and when the networking identification information is a key, the terminal device receives information sent by each network, and decrypts the information by using the key, and when the information sent by the corresponding network can be decrypted by using the key, the terminal device determines, according to decrypted content, a network matching the key, and then is added, according to the key, to a network that can be decrypted, thereby completing the networking operation.

According to this solution, in the above manner, the master device writes the networking identification information in the tag of the terminal device by using an NPC technology, so that the terminal device can be added, according to the networking identification information, to the network in which the master device is located, and when the networking identification information is written by using an NFC technology, the networking identification information can be written in the case in which the terminal device is not powered on, so that the terminal device is more convenient for a user to perform an operation when the terminal device is installed and used, and security of the established network can be ensured.

Solution 2:

Step S2101: The master device performs identification induction with the terminal device through non-contact radio frequency identification induction.

In this solution, when a user needs to add a new terminal device to a network in which the master device is located or configure a new master device network, the user can allow the master device to perform, through non-contact radio frequency identification, identification induction with the terminal device, where the non-contact radio frequency identification preferably uses NFC radio frequency identification.

Step S2102: The master device performs, according to the identification induction with the terminal device, device authentication on the terminal device, and stores device information of the terminal device.

In this solution, in order to ensure that devices added to the network in which the master device is located are all secure, when adding the terminal device, the master device can perform necessary authentication on the terminal device, for example, when the master device performs induction identification with the terminal device, the master device reads a device type of the terminal device, and the user performs device authentication according to the read device type, after authentication on the terminal device is successful, the master device stores, according to authentication information on the terminal device, device information of the terminal device in the network in which the master device is located, and only the terminal device whose device authentication information has been stored can be normally used in the network, thereby further ensuring security of the network.

Step S2103: The master device writes networking identification information in a tag of the terminal device by using an NFC technology.

In this solution, when the master device generates induction with the terminal device through non-contact radio frequency identification and is effectively authenticated, the master device writes, in the tag of the terminal device through NFC, networking identification information indicating that the terminal device is added to the network in which the master device is located, where the write operation on the NFC tag can be performed in a state in which the terminal device is not powered on and does not work, and the networking identification information written in the NFC tag of the terminal device may be: network identification information of the network in which the master device is located, and a key of network transmission data of the network in which the master device is located. The network identification information of the network in which the master device is located may use a form of a network address, for example, network addresses distinguishing different networks, and the network addresses may be specifically set to hexadecimal data. The key of the network transmission data of the network in which the master device is located may be a public key, that is, in networks established by a same master device, for data transmission, a unified key is used for encryption and decryption, different networks are distinguished by using the unified key, for use of the key, each terminal device may be configured with a private key, networks can be distinguished according to different configurations of terminal devices and keys corresponding to the terminal devices and by using the private keys, and different devices in the networks can also be distinguished. When writing the networking identification information in the tag of the terminal device, the master device may also write a series of activation instructions in the terminal devices, and only a device in which the master device writes the activation instructions can work normally after being powered on.

Step S2104: After the terminal device is powered on and activated, the terminal device reads the networking identification information in the tag.

In this solution, the master device may write the networking identification information in the NFC tag of the terminal device after the terminal device is powered on, and may also may write the networking identification information in the NFC tag of the terminal device in a case in which the terminal device is not powered on; and when the terminal device is in a normal working state after being powered on and activated, the terminal device first reads the networking identification information in the NFC tag, and the terminal device reads the networking identification information in the NFC tag through a data connection between the terminal device and the NFC tag. When a series of activation instructions are written in the tag of the terminal device and the terminal device can be in a normal working state after being powered on, the terminal device first reads the activation instructions, and then the terminal device reads the networking identification information in the NFC tag after being activated.

Step S2105: Add, according to the read networking identification information, the terminal device to the network in which the master device is located.

In this solution, after the terminal device reads the networking identification information in the NFC tag, the terminal device is added, according to different networking identification information, to the network in which the master device is located, when the networking identification information is network identification information of the network in which the master device is located, the terminal device is directly added to the corresponding network according to the network identification information, to complete establishment of the network, and when the networking identification information is the key of the network transmission data of the network in which the master device is located, the terminal device is added, according to the key, to a network in which the encrypted master device is located, to complete establishment of the network.

Step S2106: The terminal device establishes, according to a networking protocol, a mesh Internet of Things for the terminal device in the network in which the master device is located.

In this solution, after the terminal device is added to the network in which the master device is located, the terminal device may network, according to a networking protocol, other terminal devices in the network in which the master device is located, and the terminal device performs network establishment with the other terminal devices, to establish a mesh Internet of Things, where a protocol for establishing the mesh Internet of Things may specifically use: a Z-Wave wireless networking protocol or a ZigBee wireless networking protocol.

According to this solution, in the above manner, the master device communicates with terminal device through NFC, the master device writes the networking identification information in the NFC tag of the terminal device, and before writing the networking identification information, the master device may further perform necessary verification on the terminal device, so as to ensure that the terminal device added to the network in which the master device is located is secure and reliable. After the terminal device is powered on and works, the terminal device is added, according to the networking identification information in the NFC tag, to the network in which the master device is located, and establishes a mesh Internet of Things after being added to the network in which the master device is located, to complete establishment of the mesh Internet of Things. In this embodiment of the present invention, there are descriptions about that the node receives the trigger induction by receiving non-contact identification induction, and there are also descriptions about that the gateway receives the trigger induction by receiving non-contact identification induction, and generally, at least two Internet of Things devices (such as a node and a gateway) perform the trigger induction, and the manner in which the at least two Internet of Things devices receive the trigger induction by receiving the non-contact identification induction is further described in detail below:

Solution 1

Step S1201: Trigger an induction identification signal between Internet of Things devices through non-contact radio frequency identification induction.

In this solution, when it needs to construct a new Internet of Things network between the Internet of Things devices or add a new Internet of Things device to an Internet of Things network that has been established, an induction identification signal is triggered between the Internet of Things devices through non-contact radio frequency identification induction, and establishment of a new Internet of Things network is described as a specific implementation manner. Specifically, when a new Internet of Things network is established, a slave Internet of Things device and a master Internet of Things device perform non-contact radio frequency identification induction, when the slave Internet of Things device and the master Internet of Things device perform non-contact radio frequency identification induction, the slave Internet of Things device and the master Internet of Things device perform induction identification, and after the induction identification, the slave Internet of Things device and the master Internet of Things device trigger an induction identification signal separately, during specific implementation, the non-contact radio frequency identification induction used between the Internet of Things devices may be performed by using an ordinary radio frequency chip, for example, the induction identification is implemented by acquiring a signal or potential change of an input/output interface of the radio frequency chip during non-contact induction, where, preferably, an NFC technology can be used, and after the non-contact radio frequency identification induction is performed between the Internet of Things devices through NFC to trigger an induction identification signal, an induction signal is generated after the non-contact radio frequency identification induction is performed between the Internet of Things devices by using an NFC chip, and the induction signal is sent to processors of the Internet of Things devices, and the processors of the Internet of Things devices then trigger an induction identification signal.

Step S1202: Establish an Internet of Things network between the Internet of Things devices according to the triggered induction identification signal.

In this solution, after the slave Internet of Things device and the master Internet of Things device separately trigger an induction identification signal, the master Internet of Things device can establish an effective communication mechanism between the master Internet of Things device and the slave Internet of Things device; at this time, the master Internet of Things device assigns a network address separately to the master Internet of Things device and the slave Internet of Things device, the master Internet of Things device assigns the master Internet of Things device and the slave Internet of Things device to a local area network, where the manner of assigning the master Internet of Things device and the slave Internet of Things device to a local area network may be: configuring a distinguishing identifier for networks, for example, a network segment address, for the master Internet of Things device and the slave Internet of Things device, and different networks are distinguished by using the network segment address, and then the master Internet of Things device and the slave Internet of Things device establish an Internet of Things network between the Internet of Things devices according to the assigned network addresses, where the established Internet of Things network is preferably an established wireless mesh network, and a networking protocol specifically used during the networking may be a Z-Wave wireless networking protocol, a ZigBee wireless networking protocol, or the like.

According to this solution, in the above manner, an induction identification signal is triggered between Internet of Things devices through non-contact radio frequency identification induction, the Internet of Things devices establish an Internet of Things network between the Internet of Things devices according to the triggered induction identification signal, a user can be facilitated to perform a networking operation through non-contact radio frequency identification induction, and effective identification authentication can be established between the Internet of Things devices through non-contact radio frequency identification induction, thereby preventing devices from being added incorrectly.

Solution 2

Step S2201: Internet of Things devices establish identification information between the Internet of Things devices through non-contact radio frequency identification induction.

In this solution, when it needs to construct a new Internet of Things network between the Internet of Things devices or add a new Internet of Things device to an Internet of Things network that has been established, first, the identification information is established between the Internet of Things devices through non-contact radio frequency identification induction, and adding a new Internet of Things device to an Internet of Things network that has been established is introduced below. Specifically, when it needs to add a new Internet of Things device to an Internet of Things network that has been established, first, the new Internet of Things device performs non-contact radio frequency identification induction with a master Internet of Things device in the Internet of Things network that has been established, and in the Internet of Things network that has been constructed, the master Internet of Things device has permission to assign addresses in the Internet of Things network to other Internet of Things devices, and when the new Internet of Things device performs non-contact radio frequency identification induction with the master Internet of Things device, the master Internet of Things device first establishes identification information between the master Internet of Things device and the new Internet of Things device.

Step S2202: The Internet of Things devices trigger an induction identification signal according to the established identification information.

In this solution, after the identification information is established between the master Internet of Things device and the new Internet of Things device, the master Internet of Things device and the new Internet of Things device separately trigger an induction identification signal, where the induction identification signal triggered by the master Internet of Things device is an induction identification signal of the new Internet of Things device added to the Internet of Things network, and the new Internet of Things device triggers a trigger identification signal added to the Internet of Things network.

Step S2203: Add the Internet of Things devices to a same local area network according to the triggered induction identification signal.

In this solution, after the master Internet of Things device and the new Internet of Things device separately trigger an induction identification signal, the master Internet of Things device adds, according to identification information, the new Internet of Things device to an Internet of Things local area network in which the master Internet of Things device is located, where the master Internet of Things device and the slave Internet of Things device may be in an interchanged master-slave relationship, which specifically uses a manner of assigning, to the new Internet of Things device, a network address of a local area network the same as that of the master Internet of Things device, the new device can identify, by using the network address of the local area network, a local area network to which the new device is to be added, and meanwhile, the master Internet of Things device further configures an address of the Internet of Things device in the local area network for the new Internet of Things device, where the address in the local area network assigned to the new device is used for distinguishing and identifying other Internet of Things devices in the local area network.

Step S2204: Establish an Internet of Things network for the Internet of Things devices according to the local area network in which the Internet of Things devices are located.

In this solution, the Internet of Things network is established for the Internet of Things devices according to the local area network to which the Internet of Things devices are added, specifically, when a network address is assigned to the new Internet of Things device, the new Internet of Things device sends a request for networking the Internet of Things to the Internet of Things devices located in the same local area network, and if other Internet of Things devices are within an effective network identification distance, the other Internet of Things devices may make a networking reply to the new Internet of Things device when receiving the request for networking the Internet of Things sent by the new Internet of Things device; at this time, the new Internet of Things device establishes an Internet of Things network with the other Internet of Things devices, where the established Internet of Things network is a mesh Internet of Things network, and a preferred network protocol during establishment of the Internet of Things network is a Z-Wave wireless networking protocol.

According to this solution, in the above manner, identification information is established between Internet of Things devices through non-contact radio frequency identification induction, an induction identification signal is triggered according to the established identification information, after the induction identification signal is triggered, an Internet of Things network connection is established between the Internet of Things devices, and a user can conveniently perform a networking trigger operation through non-contact radio frequency identification induction, which is more convenient and rapid when the networking trigger operation is performed, and meanwhile, through non-contact radio frequency identification induction, as effective identification authentication is established between the Internet of Things devices, incorrect Internet of Things devices do not appear in the established Internet of Things network.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The computer software product is stored in a storage medium and includes several instructions for instructing a computer device (which may be a personal computer, a server, a network device, or the like) to perform all or a part of the steps of the methods described in the embodiments of the present invention. The foregoing storage medium includes: any medium that can store program code, such as a USB flash drive, a removable hard disk, a read-only memory (ROM), a random access memory (RAM), a magnetic disk, or an optical disc.

To sum up, the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments, or make equivalent replacements to some technical features thereof, as long as such modifications or replaces do not cause the essence of corresponding technical solutions to depart from the spirit and scope of the technical solutions of the embodiments of the present invention.

While there has been shown several and alternate embodiments of the present invention, it is to be understood that certain changes can be made as would be known to one skilled in the art without departing from the underlying scope of the present invention as is discussed and set forth above and below including claims. Furthermore, the embodiments described above and claims set forth below are only intended to illustrate the principles of the present invention and are not intended to limit the scope of the present invention to the disclosed elements.

What is claimed is:

1. A method for triggering networking, comprising:
receiving, by a node, non-contact trigger induction; and
adding the node and a gateway to a same network.

2. The method according to claim 1, wherein the step of receiving, by the node, the non-contact trigger induction comprises:
receiving, by the node, the trigger induction by receiving non-contact radio frequency identification induction; or
receiving, by the node, the trigger induction by detecting a change of relative displacement information.

3. The method according to claim 1, wherein the step of receiving, by the node, the non-contact trigger induction comprises:
receiving, by the node through a non-contact trigger, networking identification information indicating that the node and the gateway are added to the same network.

4. The method according to claim 1, after the step of receiving, by the node, the non-contact trigger induction, further comprising:
generating, by the node, a first wireless networking command according to the received trigger induction, and then sending, by the node, the first wireless networking command.

5. The method according to claim 4, wherein the first wireless networking command comprises:
identification authentication information of the node.

6. A method for triggering networking, comprising:
receiving, by a gateway, networking information; and
adding the gateway and a node to a same network.

7. The method according to claim 6, wherein the step of receiving, by the gateway, networking information comprises at least one of:
receiving, by the gateway, the networking information by receiving a wireless command; and
receiving, by the gateway, the networking information by receiving non-contact trigger induction.

8. The method according to claim 7, wherein the step of receiving, by the gateway, the networking information by receiving the wireless command comprises at least one of:
receiving, by the gateway, the networking information by receiving a wireless command sent by the node; and
receiving, by the gateway, the networking information by receiving a wireless command sent by an intelligent device.

9. The method according to claim 7, wherein the step of receiving, by the gateway, the networking information by receiving the non-contact trigger induction comprises:
receiving, by the gateway, the trigger induction by receiving non-contact radio frequency identification induction; or
receiving, by the gateway, the trigger induction by detecting a change of relative displacement information.

10. The method according to claim 6, wherein the step of adding the gateway and the node to the same network comprises:
generating, by the gateway, a feedback command according to the received networking information; and
then sending, by the gateway, the feedback command to the node.

11. The method according to claim 10, wherein the step of generating, by the gateway, the feedback command according to the received networking information comprises:
verifying, by the gateway, information about the node according to the received networking information; and
after verification of the gateway on the node is successful, generating, by the gateway, the feedback command.

12. The method according to claim 10, wherein the step of sending, by the gateway, the feedback command to the node comprises:
sending, by the gateway, the feedback command to the node through non-contact radio frequency identification induction; or
sending, by the gateway, the feedback command to the node by using a wireless command.

13. A node, comprising:
a first receiving unit, used for receiving, by a node, non-contact trigger induction; and
a first networking unit, used for adding the node and a gateway to a same network.

14. The node according to claim 13, wherein the first receiving unit comprises:
a first radio frequency receiving unit, used for receiving, by the node, the trigger induction by receiving non-contact radio frequency identification induction; or
a first displacement receiving unit, used for receiving, by the node, the trigger induction by detecting a change of relative displacement information.

15. The node according to claim 13, further comprising:
a networking information receiving unit, used for receiving, by the node through non-contact trigger, networking identification information indicating that the node and the gateway are added to the same network.

16. The node according to claim 13, further comprising:
a first command unit, used for generating, by the node, a first wireless networking command according to the received trigger induction, and then sending, by the node, the first wireless networking command.

17. The node according to claim 16, wherein the first wireless networking command further comprises:
identification authentication information of the node.

18. A gateway, comprising:
a second receiving unit, used for receiving, by a gateway, networking information; and
a second networking unit, used for adding the gateway and a node to a same network.

19. The gateway according to claim 18, wherein the second receiving unit comprises at least one of:
a second wireless receiving unit, used for receiving, by the gateway, the networking information by receiving a wireless command; and
a second induction receiving unit, used for receiving, by the gateway, the networking information by receiving non-contact trigger induction.

20. The gateway according to claim 19, wherein the second wireless receiving unit comprises at least one of:
a second wireless node receiving unit, used for receiving, by the gateway, the networking information by receiving a wireless command sent by the node; and
a second wireless device receiving unit, used for receiving, by the gateway, the networking information by receiving a wireless command sent by an intelligent device.

21. The gateway according to claim 19, wherein the second induction receiving unit comprises:
a second radio frequency unit, used for receiving, by the gateway, the trigger induction by receiving non-contact radio frequency identification induction; or
a second displacement unit, used for receiving, by the gateway, the trigger induction by detecting a change of relative displacement information.

22. The gateway according to claim 18, wherein the second networking unit comprises:
a second feedback generating unit, used for generating, by the gateway, a feedback command according to the received networking information; and
a second feedback sending unit, used for sending, by the gateway, the feedback command to the node.

23. The gateway according to claim 22, wherein the second feedback generating unit comprises:
a second verification unit, used for verifying, by the gateway, information about the node according to the received networking information; and
a second feedback unit, used for: after verification of the gateway on the node is successful, generating, by the gateway, the feedback command.

24. The gateway according to claim 22, wherein the second feedback sending unit comprises:
a second radio frequency feedback unit, used for sending, by the gateway, the feedback command to the node through non-contact radio frequency identification induction; or
a second wireless feedback unit, used for sending, by the gateway, the feedback command to the node by using a wireless command.
